(19) United States
(12) Patent Application Publication
(10) Pub. No.: US 2010/0118195 A1
(43) Pub. Date: May 13, 2010

(54) REMOTE CONTROL DEVICE AND OPERATING METHOD THEREOF, AND IMAGE DISPLAY APPARATUS CONTROLLED BY REMOTE CONTROL DEVICE

(75) Inventors: Ju-il EOM, Suwon-si (KR); Jae-uk HAN, Osan-si (KR); Jong-ho LEE, Seongnam-si (KR); Jin-sun PARK, Yongin-si (KR); Seok-jae RHEE, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/606,350

(22) Filed: Oct. 27, 2009

(30) Foreign Application Priority Data
Nov. 13, 2008 (KR) 10-2008-0112958

(51) Int. Cl. H04N 5/445; H04N 5/44; G06F 3/033

(52) U.S. Cl. 348/564; 348/734; 345/157; 348/E05.103; 348/E05.1

(57) ABSTRACT

A remote control device capable of being separated into two or more parts is provided. The remote control device includes a first remote controller, and a second remote controller which is capable of being connected to or separated from the first remote controller. If the first remote controller and the second remote controller are connected, the first remote controller and the second remote controller may function as a single unit, or if not, the first remote controller and the second remote controller may function as individual units.

### CROSS-REFERENCE TO RELATED APPLICATIONS

This application claims priority from Korean Patent Application No. 10-2008-0112958, filed on Nov. 13, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to a remote control device, a method for operating the remote control device and an image display apparatus controlled by the remote control device. More particularly, apparatuses and methods consistent with the present invention relate to a remote control device capable of being physically separated into two or more parts, a method for operating the remote control device and an image display apparatus controlled by the remote control device.

2. Description of the Related Art

With the development of technologies, televisions (TVs) have been able to receive various image signals using broadcast transmitters, digital versatile disks (DVDs), optical disc drives (ODDs) and storage media. However, when several users use a TV, only a single user having a remote controller is able to control the TV, and it is thus impossible to display on a single screen all images which they desire to view, which may cause inconvenience to users.

Therefore, when a plurality of users desire to view different images, they generally compromise with each other to select a single image.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a remote control device capable of being physically separated into two or more parts, a method for operating the remote control device, and an image display apparatus controlled by the remote control device.

According to an aspect of the present invention, there is provided a remote control device comprising a first remote controller, and a second remote controller which is capable of being connected to or separated from the first remote controller. The first remote controller and the second remote controller may function as a single unit if the first remote controller and the second remote controller are connected, and the first remote controller and the second remote controller may function as individual units if the first remote controller and the second remote controller are separated.

The remote control device may further comprise a first control unit which changes an operating mode of an apparatus to be controlled if the first remote controller and the second remote controller are connected or separated, the first control unit being disposed in at least one of the first remote controller and the second remote controller.

The apparatus to be controlled may be a display apparatus which displays an image on a screen.

The first control unit may control the apparatus to be operated in a normal mode if the first remote controller and the second remote controller are connected, and the first control unit may control the apparatus to be operated in a competition mode if the first remote controller and the second remote controller are separated. The normal mode may be a mode to change an image in response to manipulation of the remote control device, and the competition mode may be a mode in which the apparatus divides the screen into a plurality of areas, changes a plurality of partial images displayed on the plurality of areas according to individual control signals of the first remote controller and second remote controller, and displays on a full screen an image having partial images which occupy a large number of areas of the screen after a predetermined time elapses.

Each of the first remote controller and the second remote controller may comprise a connector which connects the first remote controller and the second remote controller, a transmitter which transmits a remote control signal, a pointer display unit which displays a pointer on a screen of an apparatus to be controlled, and a key pad which comprises one or more remote control keys.

Each of the first remote controller and the second remote controller may comprise a connector which connects the first remote controller and the second remote controller, a first sensor which senses a posture of the first remote controller and the second remote controller, a transmitter which transmits a remote control signal to display a pointer on a screen of an apparatus to be controlled and to move the pointer according to the posture sensed by the first sensor, and a key pad which comprises one or more remote control keys.

Each of the first remote controller and the second remote controller may comprise a second sensor which senses vibration of the first remote controller and the second remote controller, a counter which counts the number of vibration sensed by the second sensor, and a second control unit which enables a selection of the plurality of areas of the screen according to the number of vibration counted by the counter.

Each of the first remote controller and the second remote controller may comprise a connector which connects the first remote controller and the second remote controller, and a second control unit which controls an apparatus to be controlled. The second control unit of the first remote controller may perform the same function as the second control unit of the second remote controller.

Each of the first remote controller and the second remote controller may further comprise a pointer display unit which displays a pointer on a screen of the apparatus. Both the second control unit of the first remote controller and the second control unit of the second remote controller may generate a signal to display the pointer.

At least one of the first remote controller and the second remote controller may further comprise a key pad which comprises one or more remote control keys.

According to another aspect of the present invention, there is provided a remote control device comprising a plurality of remote controllers which are capable of being connected or separated. The plurality of remote controllers may function as a single unit if the plurality of remote controllers are connected, and the plurality of remote controllers may function as individual units if the plurality of remote controllers are separated.

According to another aspect of the present invention, there is provided an image display apparatus comprising a signal receiver which receives a remote control signal from a remote control device comprising a plurality of remote controllers which are capable of being connected or separated; a display unit which displays an image on a screen; a control unit which, if the plurality of remote controllers are separated, controls the display unit to divide the screen into a plurality of areas, to change a plurality of partial images displayed on the plurality of areas according to individual control signals of the plurality of remote controllers, and to display on a full screen an image having partial images which occupy a large number of areas of the screen after a predetermined time elapses.

According to another aspect of the present invention, there is provided a method for operating a remote control device comprising a plurality of remote controllers which are capable of being connected or separated, the method comprising connecting or separating the plurality of remote controllers, and changing an operating mode of an apparatus to be controlled, according to whether the plurality of remote controllers are connected or separated.

The changing may comprise controlling the apparatus to be operated in a normal mode if the plurality of remote controllers are connected, and controlling the plurality of remote controllers to function as individual units if the plurality of remote controllers are separated. The normal mode may be a mode to change an image in response to manipulation of the remote control device.

The apparatus to be controlled may be a display apparatus which displays an image on a screen.

The controlling the plurality of remote controllers may comprise the apparatus dividing the screen into a plurality of areas, and changing a plurality of partial images displayed on the plurality of areas according to individual control signals of the plurality of remote controllers; and displaying on a full screen an image having partial images which occupy a large number of areas of the screen after a predetermined time elapses.

The changing may comprise transmitting a remote control signal to display a pointer on the plurality of areas of the screen, and changing a partial image displayed on an area indicated by the pointer among the plurality of areas of the screen.

The method may further comprise counting the number of vibration of the plurality of remote controllers, and enabling a selection of the plurality of areas of the screen according to the counted number of vibration.

The plurality of partial images may be obtained by dividing each of a plurality of images for competition according to the number of the plurality of areas of the screen, and may be changed to another plurality of partial images of one of the plurality of images for competition whenever the plurality of remote controllers point, and the changed partial images are displayed.

According to another aspect of the present invention, there is provided a method for operating a remote control device comprising a plurality of remote controllers which are capable of being connected or separated, the method comprising connecting or separating the plurality of remote controllers, and controlling the plurality of remote controllers to function as individual units to perform the same function if the plurality of remote controllers are separated.

The controlling may comprise controlling the plurality of remote controllers to generate a signal to display a pointer.

In an exemplary embodiment there is a remote control system including: a first remote control comprising a first housing; and a second remote control a second housing, wherein the first housing is configured to be physically attached to the second housing in a first mode and the first housing is not physically attached to the second housing in a second mode, and wherein in the first mode, the first and the second remote controls are operated as a single remote and in the second mode the first and the second remotes are separately operated.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 exemplarily illustrates a first remote controller and second remote controller of a remote control device which are connected according to an exemplary embodiment of the present invention;

FIG. 2 exemplarily illustrates the first remote controller and second remote controller of the remote control device of FIG. 1 which are separated according to an exemplary embodiment of the present invention;

FIG. 3 is a block diagram illustrating a system comprising a first remote controller and an image display apparatus according to an exemplary embodiment of the present invention;

FIG. 4 is a block diagram illustrating a system comprising a first remote controller and an image display apparatus according to another exemplary embodiment of the present invention;

FIGS. 5A to 5F exemplarily illustrate various forms of a remote control device according to exemplary embodiments of the present invention;

FIGS. 6 to 10 exemplarily illustrate screens of an image display apparatus to explain a competition mode when a first remote controller and second remote controller of a remote control device are separated according to exemplary embodiments of the present invention;

FIG. 11 is a flowchart explaining a method for operating a remote control device according to an exemplary embodiment of the present invention;

FIG. 12 is a flowchart explaining a method for operating a plurality of remote controllers of a remote control device according to an exemplary embodiment of the present invention; and

FIG. 13 is a flowchart explaining a method for controlling a competition mode of an image display apparatus according to an exemplary embodiment of the present invention.

### DETAILED DESCRIPTION OF EXEMPLARY EMBODIMENTS

Certain exemplary embodiments of the present invention will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail. Expression such as “at least one of,” when preceding a list of elements, modifies the entire list of elements and does not modify each element of the list.

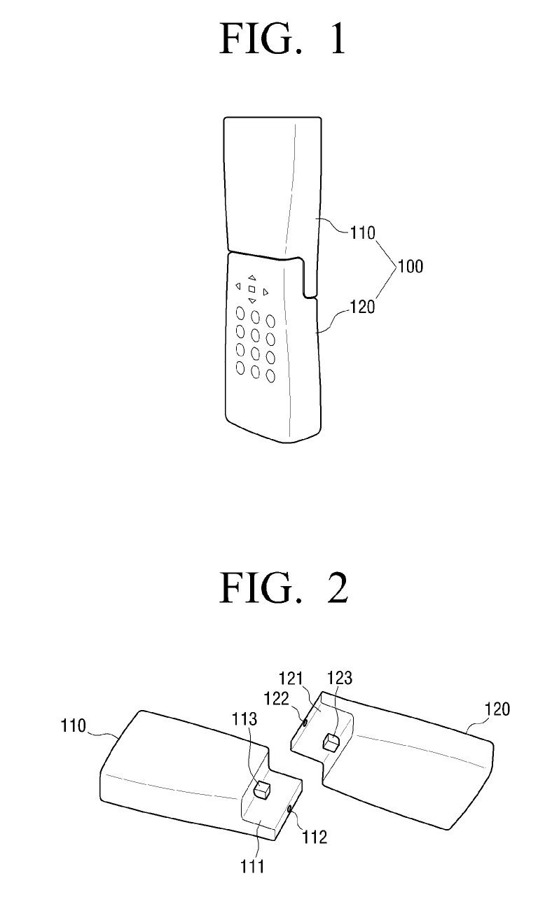

FIG. 1 exemplarily illustrates a remote control device 100 according to an exemplary embodiment of the present invention. The remote control device 100 of FIG. 1 comprises a first remote controller 110 and a second remote controller 120, which are connected to each other. Alternatively, the first remote controller 110 and second remote controller 120 may be separated to perform their respective functions.

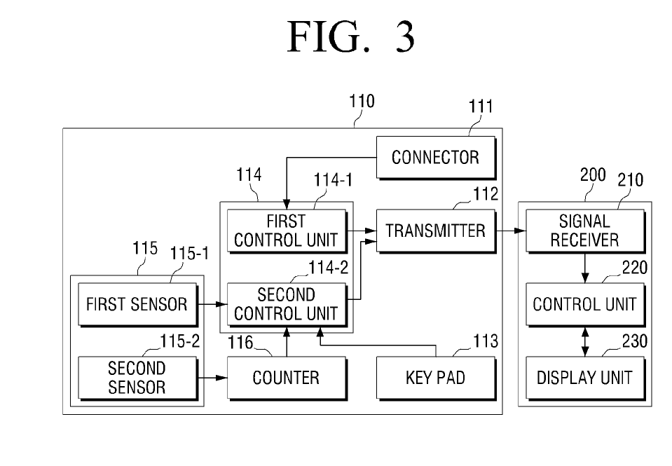

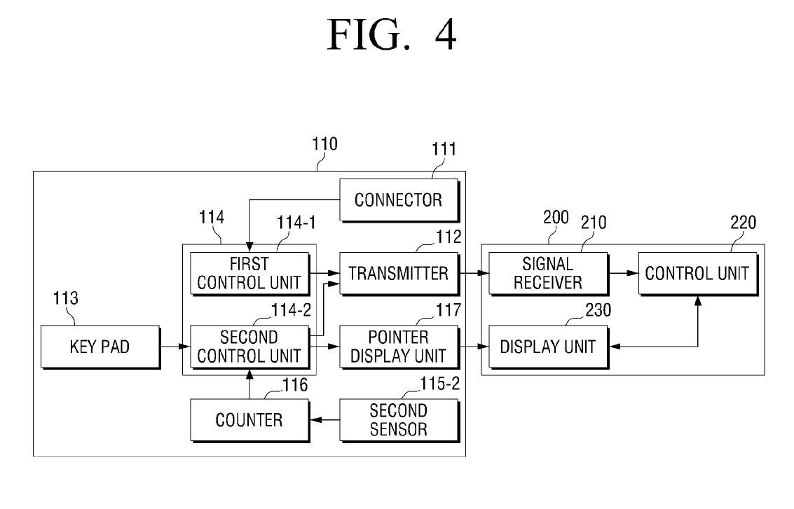

FIG. 2 exemplarily illustrates the first remote controller 110 and second remote controller 120 which are separated. The first remote controller 110 comprises a connector 111 which enables connection between the first remote controller 110 and the second remote controller 120, a transmitter 112 which transmits a remote control signal, and a key pad 113. The second remote controller 120 also comprises a connector 121, a transmitter 122 and a key pad 123 which are configured in substantially the same manner as those of the first remote controller 110. Thus, the second remote controller 120 may perform substantially the same function as the first remote controller 110. The first and second remote controllers 110 and 120 will be described later in detail with reference to FIGS. 3 and 4.

FIG. 3 is a block diagram illustrating a system comprising the first remote controller 110 and an image display apparatus 200. In FIG. 3, the first remote controller 110 comprises a control unit 114, a sensor 115 and a counter 116 in addition to the connector 111, the transmitter 112 and the key pad 113 described above. Although not shown in FIG. 3, the second remote controller 120 may be configured in substantially the same manner as the first remote controller 110.

The connector 111 of the first remote controller 110 is capable of being connected to the connector 121 of the second remote controller 120, and may be implemented as a magnetic connector. Alternatively, the connector 111 may have a protruding portion and the connector 121 may have a groove portion, so that the protruding portion of the connector 111 may be inserted into the groove portion of the connector 121, and thus the first remote controller 110 may be connected to the second remote controller 120.

The control unit 114 comprises a first control unit 114-1 and a second control unit 114-2. The first control unit 114-1 detects whether or not the first and second remote controllers 110 and 120 are connected, and changes an operating mode of an apparatus to be controlled. Here, the apparatus to be controlled may be the image display apparatus 200 which displays an image on a screen. Additionally, the image displayed on the screen may comprise an image receivable from an external source such as a broadcast channel, a digital versatile disk (DVD) player and an external storage medium and displayable on the image display apparatus 200.

The first control unit 114-1 may be included in either the first remote controller 110 or the second remote controller 120.

If it is determined that the first remote controller 110 and second remote controller 120 are connected, the first control unit 114-1 may control the image display apparatus 200 to be operated in a normal mode which enables a user to change a currently displayed image by manipulating the remote control device 100, or if not, the first control unit 114-1 may control the image display apparatus 200 to be operated in a competition mode.

The normal mode enables general functions of a TV remote controller to be performed, for example a broadcast channel control function such as channel up and down or volume up and down, or a TV setting function such as sound, image and external apparatus settings.

The competition mode enables at least two users to determine which single display image is to be displayed by playing a game when they desire to view different images. In more detail, if the competition mode is set, the image display apparatus 200 may divide the screen into a plurality of areas, may change a plurality of partial images displayed on the plurality of areas respectively according to individual control signals of the first and second remote controllers 110 and 120. After a predetermined time elapses, the image display apparatus 200 may display on the full screen an image having partial images which occupy a large number of areas on the screen among the plurality of partial images.

Additionally, upon determining that the first remote controller 110 and second remote controller 120 are connected, the first controller 114-1 disables a competition mode-related function of the first remote controller 110 and second remote controller 120. If the first control unit 114-1 determines that the first remote controller 110 and second remote controller 120 are separated, the second control unit 114-2 controls operations of the first remote controller 110.

The transmitter 112 of the first remote controller 110 transmits a remote control signal to the image display apparatus 200. In more detail, the transmitter 112 transmits to the image display apparatus 200 a remote control signal to change a current operating mode of the image display apparatus 200 to the competition mode when the first remote controller 110 and second remote controller 120 are separated. After change to the competition mode, the transmitter 112 also transmits to the image display apparatus 200 a remote control signal in response to user manipulation of the first remote controller 110 or second remote controller 120.

The sensor 115 comprises a first sensor 115-1 for sensing a posture, i.e., the orientation, of the first remote controller 110 and a second sensor 115-2 for sensing a motion of the first remote controller 110.

The first sensor 115-1 senses movement of a front end of the first remote controller 110, namely a side in which the transmitter 112 is placed, and sends the result of sensing to the second control unit 114-2. The first sensor 115-1 may be implemented as a biaxial gyro sensor and a terrestrial magnetism sensor.

The second control unit 114-2 generates a signal for displaying a pointer on the screen of the image display apparatus 200, and transmits to the image display apparatus 200 the signal for displaying the pointer as a remote control signal to move the pointer based on the result of sensing of the first sensor 115-1 via the transmitter 112.

The front end of the first remote controller 110 may be moved by a user on a virtual plane (VP) in an upward or a downward direction, or to the left or right, or in a direction combining two of these directions, such as an upper-leftward direction, for instance. That is, the front end of the first remote controller 110 may be moved in any direction. The VP is in a parallel relation with the screen of the image display apparatus 200.

When the front end of the first remote controller 110 is moved on the VP, a pointer P displayed on the screen of the image display apparatus 200 moves in the same direction as the front end of the first remote controller 110. For example, if a user moves the front end of the first remote controller 110 upwards on the VP, the pointer P may move upwards, and if the user moves the front end of the first remote controller 110 to the upper-left on the VP, the pointer P may move to the upper-left.

Thus, the pointer P displayed on the screen of the image display apparatus 200 may be moved by the user spatially moving the first remote controller 110.

The VP may not be in a perfect parallel relation with the screen of the image display apparatus 200, and may not be a perfect plane. That is, it is practically impossible for the movement of the front end of the first remote controller 110 by the user to be on a perfect plane and in a perfect parallel relation with the screen of the image display apparatus 200.

Accordingly, exemplary embodiments of the present invention may be applicable to a situation in which the front end of the first remote controller 110 moves on an imperfect plane and in an imperfect parallel relation with the screen of the image display apparatus 200.

If a user presses a pointing record button using the key pad 113, the second control unit 114-2 transmits information regarding movement such as a direction of movement, a distance moved, or other information, which is obtained from the sensing result transmitted from the first sensor 115-1, to the image display apparatus 200 via the transmitter 112.

While the key pad 113 is implemented by a single button as shown in FIG. 2, exemplary embodiments of the present invention are also applicable to a key pad comprising a power button, a channel button, a volume button, a selection button, or other buttons.

The second sensor 115-2 may be implemented as an acceleration sensor which senses a motion of the first remote controller 110. The counter 116 counts the number of motions of the first remote controller 110 sensed by the second sensor 115-2. A single motion may be to-and-fro, so the counter 116 counts the number of times the first remote controller 110 is moved back and forth.

The second control unit 114-2 provides the number of pointing records, i.e., the number of times the pointing record button is pressed, so that the pointer P may be moved as many times as the number of motions counted by the counter 116.

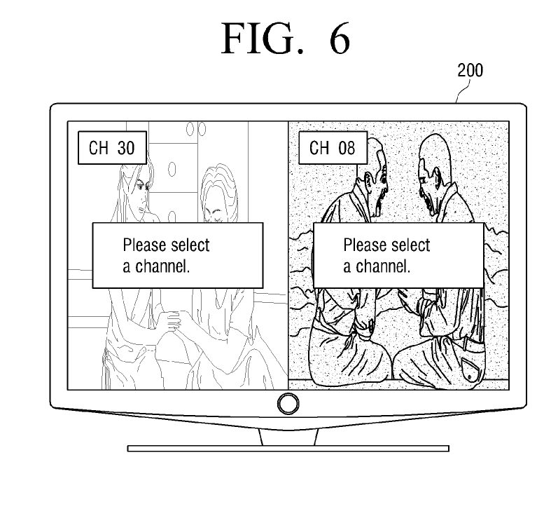

The image display apparatus 200 comprises a signal receiver 210, a control unit 220 and a display 230. The operations of the first remote controller 110 and the competition mode of the image display apparatus 200 under the control of the second control unit 114-2 will be described later in detail with reference to FIGS. 6 to 10.

The signal receiver 210 receives the remote control signal from the first remote controller 110 or second remote controller 120, and the control unit 220 then changes the current operating mode of the image display apparatus 200 to the competition mode in response to the remote control signal.

In the competition mode, the display unit 230 displays an initial setting window to receive a selection of channels for competition, under the control of the control unit 220, as shown in FIG. 6.

The channels for competition may be previously set using a picture-in-picture (PIP) function of the image display apparatus 200 prior to entering the competition mode. In this situation, there is no need to display the initial setting window.

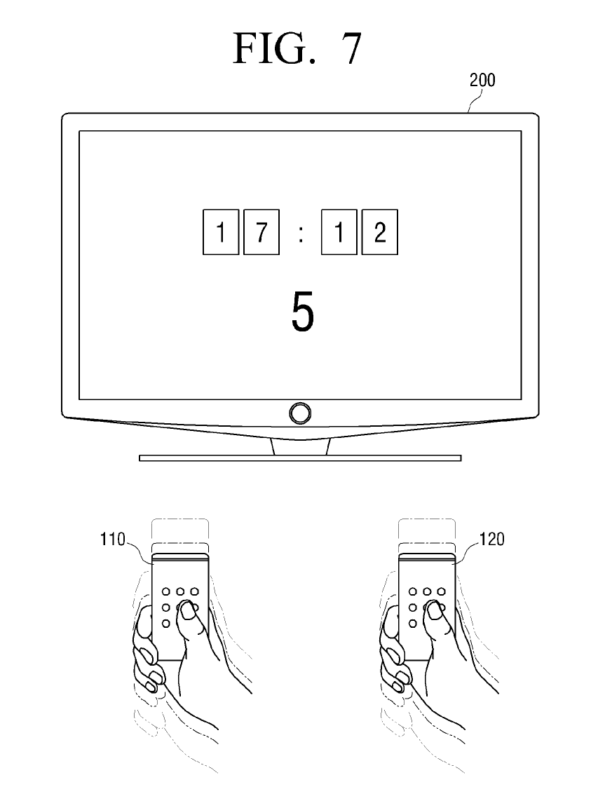

If channels for competition are input or have been previously set, the control unit 220 may enable two or more users to ensure the number of pointing records using their remote controllers (namely, the first remote controller 110 or the second remote controller 120) for a predetermined time. Referring to FIG. 7, a first user and a second user may ensure the number of pointing records by moving the first remote controller 110 and the second remote controller 120, respectively, for five seconds prior to starting a game.

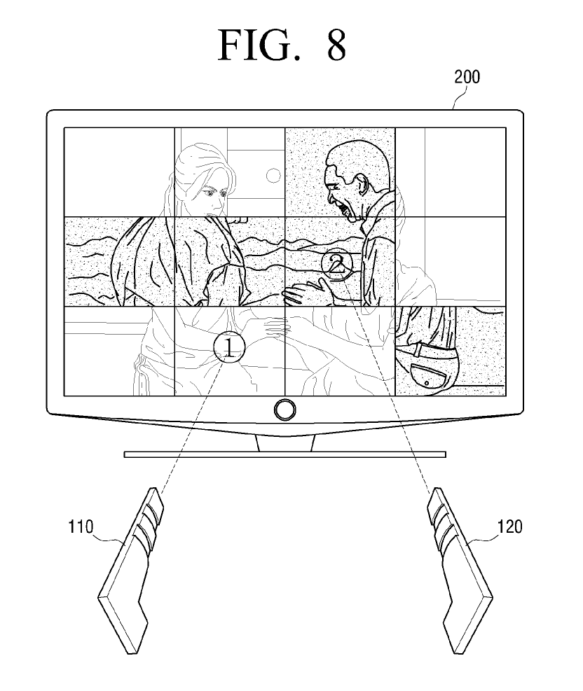

After a predetermined time has elapsed, the control unit 220 starts the game under the control of the first remote controller 110 and second remote controller 120, as shown in FIG. 8. In more detail, the control unit 220 controls the display unit 230 to divide the screen into a plurality of areas.

The control unit 220 also controls the display unit 230 to divide each of a first image and a second image into a plurality of partial images according to the number of areas into which the screen is divided, and to display the plurality of partial images on the plurality of areas. Here, the first image is received via a channel selected by the first user using the first remote controller 110, and the second image is received via a channel selected by the second user using the second remote controller 120. Additionally, the number of partial images of the first image may be identical to the number of partial images of the second image, and the plurality of partial images may be displayed on the screen in a random order.

The control unit 220 makes a change in the plurality of partial images displayed on the plurality of areas, whenever receiving a remote control signal to display a pointer from the first remote controller 110 and second remote controller 120. For example, if a pointer under the control of the second remote controller 120, points at a first area on which one of the partial images of the first image is displayed, the control unit 220 may control the display unit 230 to display one of the partial images of the second image on the first area, instead.

After a preset game time has elapsed, the control unit 220 controls the display unit 230 to compute the number of partial images of the first image and the number of partial images of the second image, and to display on the full screen an image having partial images occupying a large number of areas of the screen between the first image and second image. In this situation, the first image is received via a channel set by the first remote controller 110, and the second image is received via a channel set by the second remote controller 120.

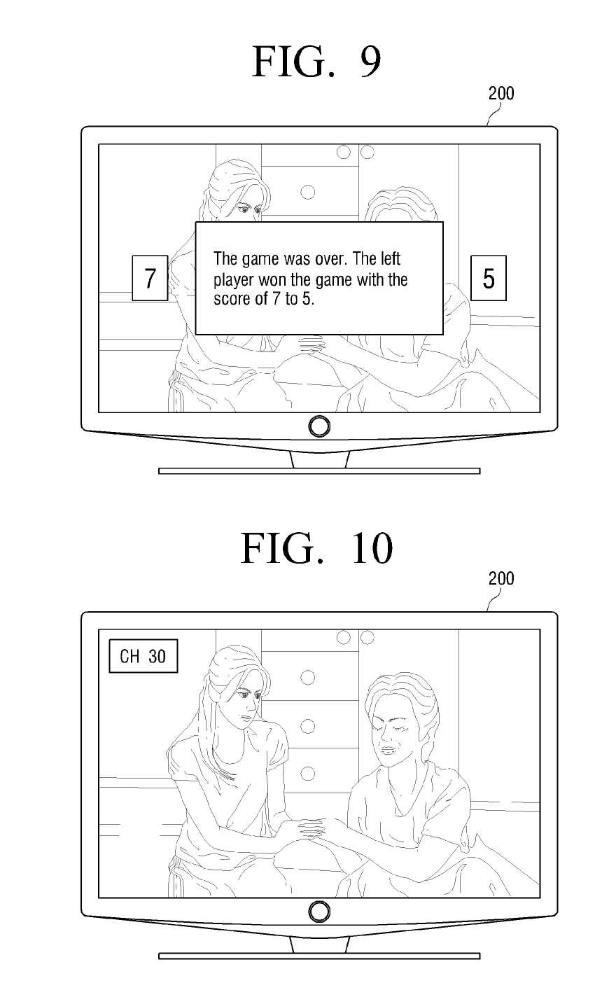

Referring to FIGS. 9 and 10, the number of partial images on channel 30 set by a user of the first remote controller 110 is greater than that of partial images on channel 8 set by a user of the second remote controller 120. Accordingly, an image corresponding to channel 30 is displayed on the full screen, and the competition mode is terminated. The users may then combine the first remote controller 110 and the second remote controller 120, to control video and sound received via channel 30.

FIG. 4 is a block diagram illustrating a system comprising the first remote controller 110 and the image display apparatus 200 according to another exemplary embodiment of the present invention. In FIG. 4, the first remote controller 110 comprises a connector 111, a transmitter 112, a key pad 113, a control unit 114, a counter 116 and a pointer display unit 117. The pointer display unit 117 of FIG. 4 is included instead of the first sensor 115-1 shown in FIG. 3. Components other than the pointer display unit 117 in the system of FIG. 4 perform substantially the same functions as those shown in FIG. 3, so no further description is herein provided.

The pointer display unit 117 displays a pointer on the screen of the image display apparatus 200, and may be implemented as a laser pointer.

If a user selects a screen selection button when the pointer is currently displayed on the screen by the pointer display unit 117, the second control unit 114-2 transmits a remote control signal to change a partial image displayed on an area of the screen pointed by the pointer to the image display apparatus 200 via the transmitter 112.

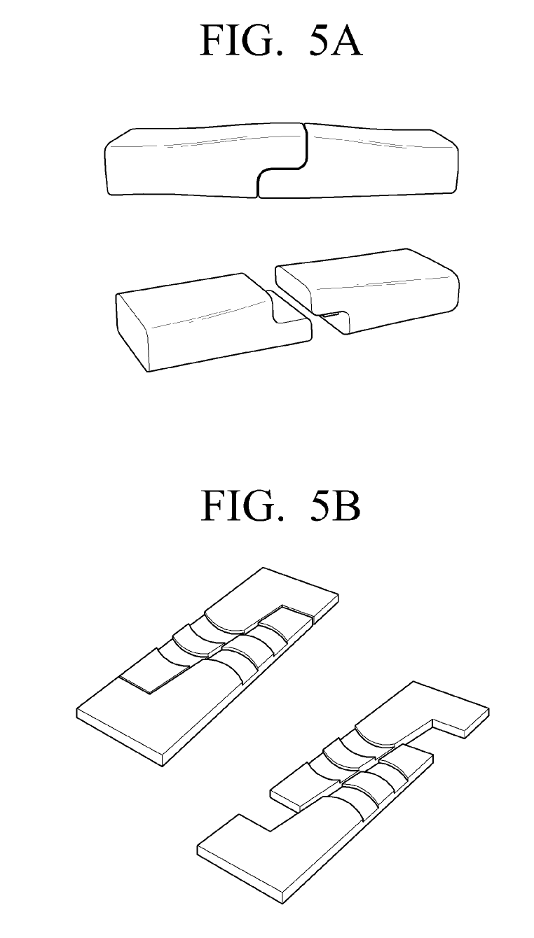

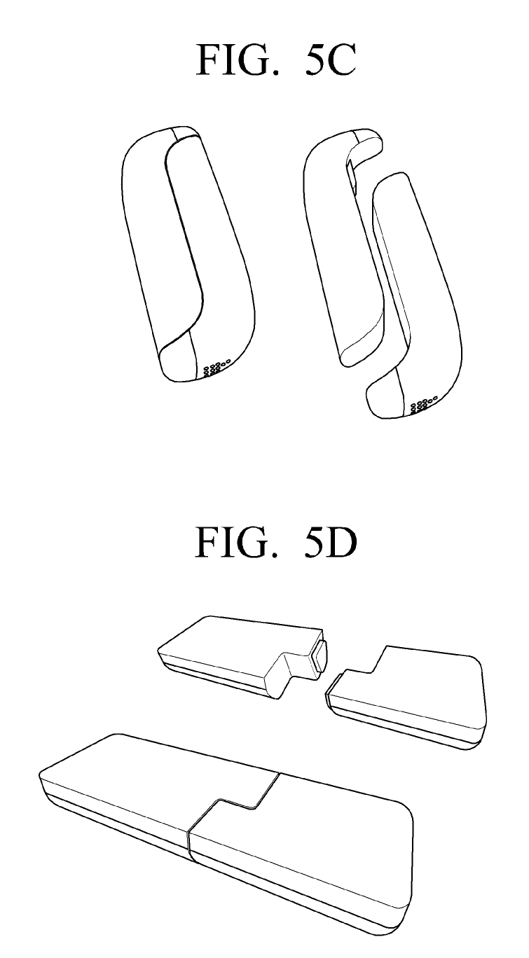

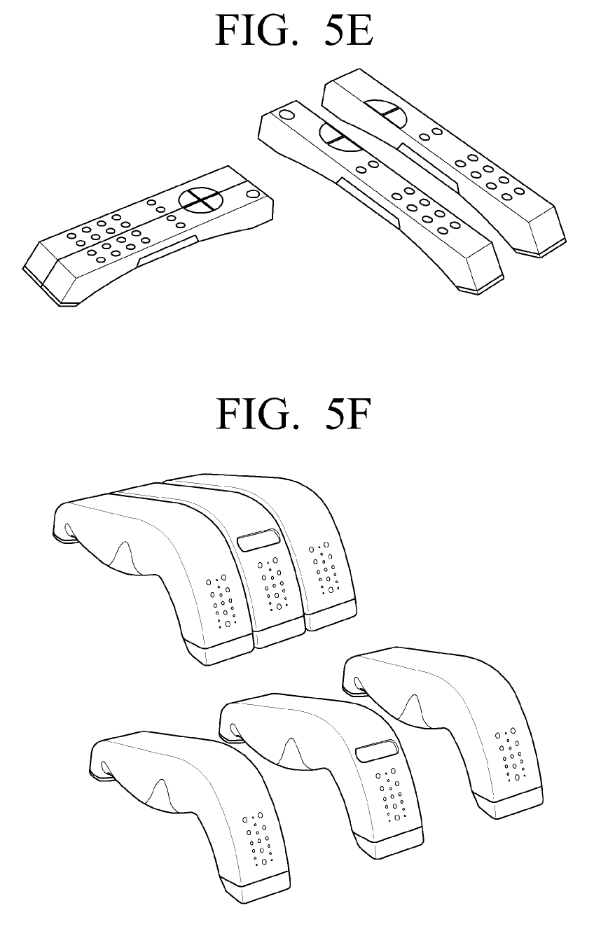

While the remote control device 100 comprises two remote controllers, namely the first remote controller 110 and second remote controller 120 in the exemplary embodiment of the present invention, there is no limitation thereto. Accordingly, exemplary embodiments of the present invention are also applicable to a remote control device having a plurality of remote controllers in various forms as shown in FIGS. 5A to 5F.

Additionally, a broadcast image is received by the channel for competition in the exemplary embodiment of the present invention, but there is no limitation thereto. Accordingly, a DVD image capable of being displayed on an image display apparatus, and an image stored in a storage medium may also be received by the channel for competition.

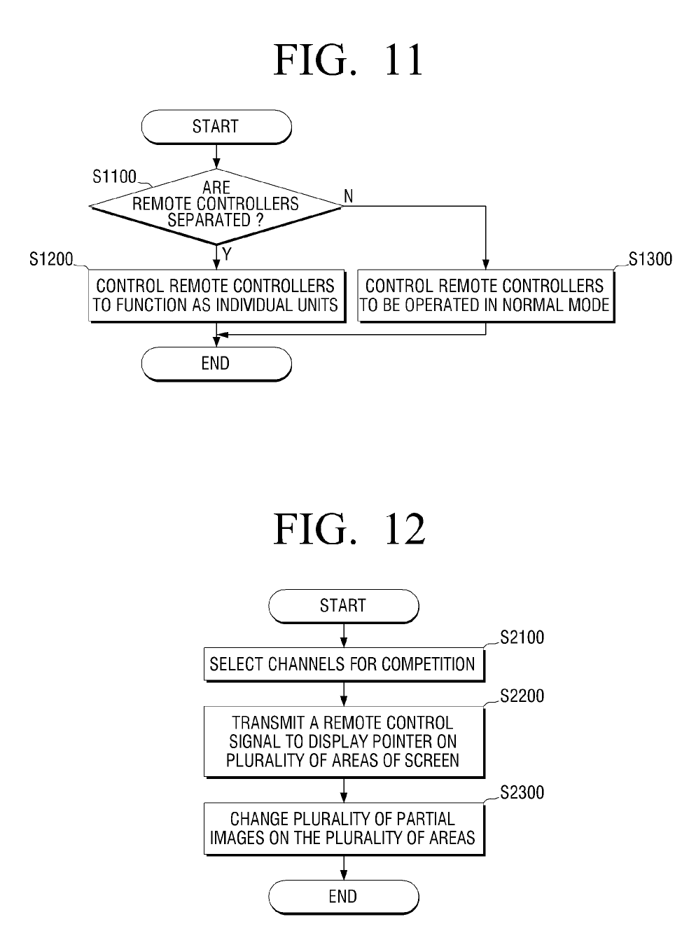

FIG. 11 is a flowchart explaining a method for operating a remote control device according to an exemplary embodiment of the present invention. In FIG. 11, the remote control device comprises a plurality of remote controllers which are capable of being separated or connected, and an operating mode of an apparatus to be controlled may be changed according to whether or not the plurality of remote controllers are separated (S1100). The apparatus to be controlled may be an image display apparatus capable of displaying an image on a screen.

If it is determined that the plurality of remote controllers are separated (S1100:Y), the plurality of remote controllers function as individual units (S1200). Alternatively, if it is determined that the plurality of remote controllers are connected (S1100:N), the normal mode is set to control general functions and settings of an image display apparatus (S1300).

A method for operating the plurality of remote controllers which are separated is now described with reference to FIG. 12.

In FIG. 12, channels for competition are selected (S2100), a remote control signal to display a pointer on a plurality of areas of a screen of the image display apparatus is transmitted to the image display apparatus 200 (S2200), and a plurality of partial images appearing on the plurality of areas are changed (S2300).

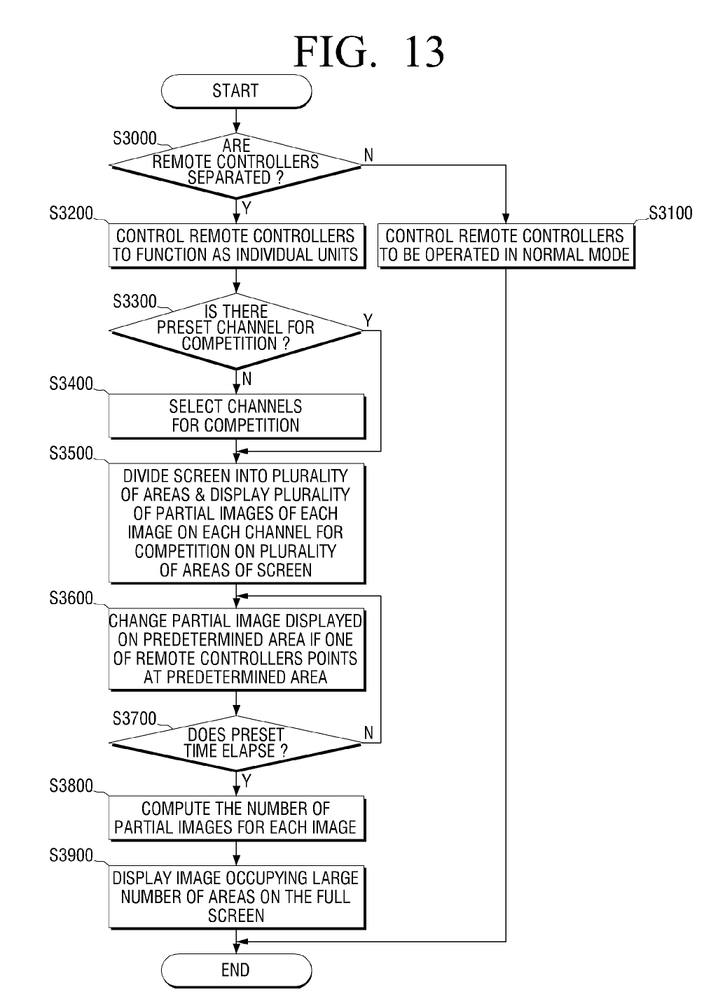

FIG. 13 is a flowchart explaining a method for controlling a competition mode of an image display apparatus according to an exemplary embodiment of the present invention. In FIG. 13, a remote control device comprising a plurality of remote controllers which are capable of being separated or connected controls the competition mode of the image display apparatus. In this situation, an operating mode of the image display apparatus may be changed according to whether or not the plurality of remote controllers are separated (S3000).

If it is determined that the plurality of remote controllers are connected (S3000:N), the normal mode is set to control general functions and settings of the image display apparatus (S3100).

If it is determined that the plurality of remote controllers are separated (S3000:Y), the image display apparatus receives a remote control signal to change a current operating mode to the competition mode, so that the image display apparatus is operated in the competition mode (S3200).

If there is no preset channel for competition (S3300:N), a plurality of users select desired channels using their own remote controllers (S3400). Alternatively, if channels for competition have been previously set using the PIP function (S3300:Y), these channels are automatically selected.

After operation S3400, the screen is divided into a plurality of areas, and a plurality of partial images of each image received by each channel for competition are displayed on the plurality of areas (S3500). In this situation, the number of displayed partial images may be the same.

If one of the plurality of remote controllers points at a predetermined area, a partial image displayed on the predetermined area is changed (S3600). If a preset time elapses (S3700:Y), the number of partial images for each image is computed (S3800).

An image occupying a large number of areas of the screen is displayed on the full screen (S3900), and the competition mode is terminated.

Therefore, it is possible for a user to easily enter a competition mode by physically separating the plurality of remote controllers, and to decide an image to be displayed by playing a game, which provides the user with entertainment.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A remote control device comprising:
a first remote controller; and
a second remote controller which is configured to be connected to or separated from the first remote controller,
wherein the first remote controller and the second remote controller function as a single unit if the first remote controller and the second remote controller are connected, and
wherein the first remote controller and the second remote controller function as separate individual units if the first remote controller and the second remote controller are separated.

2. The remote control device as claimed in claim 1, further comprising:
a first control unit which changes an operating mode of an apparatus if the first remote controller and the second remote controller are connected or separated, the first control unit being disposed in at least one of the first remote controller and the second remote controller.

3. The remote control device as claimed in claim 2, wherein the apparatus is a display apparatus which displays an image on a screen.

4. The remote control device as claimed in claim 3, wherein the first control unit controls the apparatus to operate in a normal mode if the first remote controller and the second remote controller are connected, and the first control unit controls the apparatus to operate in a competition mode if the first remote controller and the second remote controller are separated,
wherein the normal mode is a mode to change the image in response to a manipulation of the remote control device, and the competition mode is a mode in which the apparatus divides the screen into a plurality of areas, changes a plurality of partial images displayed on the plurality of areas according to individual control signals of the first remote controller and second remote controller, and displays on a full screen an image having partial images which occupy a number of areas of the screen after a predetermined time elapses.

5. The remote control device as claimed in claim 1, wherein the first remote controller comprises:
a connector which connects the first remote controller to the second remote controller;
a transmitter which transmits a remote control signal;
a pointer display unit which displays a pointer on a screen of an apparatus controlled; and
a key pad which comprises one or more remote control keys.

6. The remote control device as claimed in claim 1, wherein the first remote controller comprises:
a connector which connects the first remote controller to the second remote controller;
a first sensor which senses an orientation of the first remote controller;
a transmitter which transmits a remote control signal to display a pointer on a screen of an apparatus and to move the pointer according to the orientation sensed by the first sensor; and
a key pad which comprises one or more remote control keys.

7. The remote control device as claimed in claim 5, wherein the first remote controller comprises:
a second sensor which senses a motion of the first remote controller;
a counter which counts a number of motions sensed by the second sensor; and
a second control unit which enables a selection of the plurality of areas of the screen according to the number of motions counted by the counter.

8. The remote control device as claimed in claim 6, wherein the first remote controller comprises:
a second sensor which senses motions the first remote controller;
a counter which counts a number of motions sensed by the second sensor; and
a second control unit which enables a selection of the plurality of areas of the screen according to the number of motions counted by the counter.

9. The remote control device as claimed in claim 1, wherein the first remote controller comprises:
a connector which connects the first remote controller to the second remote controller; and
a second control unit which controls an apparatus,
wherein the second control unit of the first remote controller performs a same function as a second control unit of the second remote controller.

10. The remote control device as claimed in claim 9, wherein the first remote controller further comprises:
a pointer display unit which displays a pointer on a screen of the apparatus,
wherein the second control unit of the first remote controller generates a signal to display the pointer.

11. The remote control device as claimed in claim 10, wherein the first remote controller further comprises a key pad which comprises one or more remote control keys.

12. A remote control device comprising:
a plurality of remote controllers which are configured to be connected or separated,
wherein the plurality of remote controllers function as a single unit if the plurality of remote controllers are connected, and
wherein the plurality of remote controllers function as separate individual units if the plurality of remote controllers are separated.

13. An image display apparatus comprising:
a signal receiver which receives a remote control signal from a remote control device comprising a plurality of remote controllers which are configured to be connected or separated;
a display unit which displays an image on a screen;
a control unit which, if the plurality of remote controllers are separated, controls the display unit to divide the screen into a plurality of areas, to change a plurality of partial images displayed on the plurality of areas according to individual control signals of the plurality of remote controllers, and to display on a full screen an image having partial images which occupy a number of areas of the screen after a predetermined time elapses.

14. A method for operating a remote control device including a plurality of remote controllers which are configured to be connected or separated, the method comprising:
connecting or separating the plurality of remote controllers; and
changing an operating mode of an apparatus, according to whether the plurality of remote controllers are connected or separated.

15. The method as claimed in claim 14, wherein the changing comprises:
controlling the apparatus to operate in a normal mode if the plurality of remote controllers are connected, and controlling the plurality of remote controllers to function as separate individual units if the plurality of remote controllers are separated,
wherein the normal mode is a mode to change an image in response to manipulation of the remote control device.

16. The method as claimed in claim 15, wherein the apparatus is a display apparatus which displays the image on a screen.

17. The method as claimed in claim 16, wherein the controlling the plurality of remote controllers comprises:
dividing by the apparatus, the screen into a plurality of areas, and changing a plurality of partial images displayed on the plurality of areas according to individual control signals of the plurality of remote controllers; and
displaying on a full screen an image having partial images which occupy a number of areas of the screen after a predetermined time elapses.

18. The method as claimed in claim 17, wherein the changing the plurality of partial images comprises:
transmitting a remote control signal to display a pointer on the plurality of areas of the screen, and changing a partial image of the plurality of partial images displayed on an area indicated by the pointer among the plurality of areas of the screen.

19. The method as claimed in claim 17, further comprising:
counting a number of motions of the plurality of remote controllers; and
enabling a selection of the plurality of areas of the screen according to the counted number of motions.

20. The method as claimed in claim 18, further comprising:
counting a number of motions of the plurality of remote controllers; and
enabling a selection of the plurality of areas of the screen according to the counted number of motions.

21. The method as claimed in claim 17, wherein the plurality of partial images are obtained by dividing each of a plurality of images for competition according to the number of the plurality of areas of the screen, and
wherein the plurality of partial images are changed to another plurality of partial images of one of the plurality of images for competition whenever the plurality of remote controllers point, and the another plurality of partial images are displayed.

22. A method for operating a remote control device including a plurality of remote controllers which are configured to be connected or separated, the method comprising:
connecting or separating the plurality of remote controllers; and
controlling the plurality of remote controllers to function as separate individual units to perform a same function if the plurality of remote controllers are separated.

23. The method as claimed in claim 22, wherein the controlling comprises controlling the plurality of remote controllers to generate a signal to display a pointer.

24. A remote control system comprising:
a first remote control comprising a first housing; and
a second remote control a second housing,
wherein the first housing is configured to be physically attached to the second housing in a first mode and the first housing is not physically attached to the second housing in a second mode, and
wherein in the first mode, the first and the second remote controls are operated as a single remote and in the second mode the first and the second remotes are separately operated.

25. The remote system of claim 24, wherein the second mode is a game mode and a first user operates the first remote and a second user operates the second remote.
